(19) United States
(12) Patent Application Publication
(10) Pub. No.: US 2012/0012008 A1
(43) Pub. Date: Jan. 19, 2012

(54) TEA BREWING APPARATUS

(75) Inventor: Randolph Chin Pang Kwok, Hong Kong SAR (CN)

(73) Assignee: HOP SHING METAL & PLASTIC MANUFACTORY LTD., Kwai Chung (HK)

(21) Appl. No.: 12/837,799

(22) Filed: Jul. 16, 2010

(51) Int. Cl. A47J 31/20; A47J 31/06

(52) U.S. Cl. 99/297; 99/299

(57) ABSTRACT

A tea brewing apparatus includes a tea steeping assembly received in a vessel such as a kettle or tea pot, for raising and lowering tea leaves with respect to the brewing water without opening the lid. The tea steeping assembly includes an outer filter including a perforated container, and in which a tea strainer is slidingly received. A lid is mounted for rotation on the filter; and a telescopic coupling connects the lid and the tea strainer so they rotate together. A cam and a follower cooperate such that rotation of the lid engages the follower with the cam to raise and lower the strainer.

### TECHNICAL FIELD

The present invention relates to tea brewing apparatus incorporating a tea strainer.

### BACKGROUND OF THE INVENTION

When brewing tea an important consideration is to ensure that the tea leaves are in appropriate contact with the water. A number of variables affect the strength of tea—the relative quantities of brewing water and tea leaves, the water temperature and the steeping time all play an important part. There is a need, therefore, for a device allowing tea to be more readily brewed according to taste, and which provides greater control over these different variables.

When making tea with loose tea leaves, preventing the tea leaves from being dispensed with the tea when it is poured out is another issue to that must be addressed. One means of achieving this is to provide a tea strainer separate from the tea pot and through which the tea is poured so that any tea leaves poured out of the tea pot will be collected in the strainer. To avoid the need for such a separate strainer it will be advantageous to provide a tea brewing vessel with an internal strainer.

It is an object of the present invention to address the above needs or more generally to provide an improved tea brewing apparatus.

### DISCLOSURE OF THE INVENTION

According to one aspect of the present invention there is provided tea brewing apparatus comprising:

a vessel having a pouring device and a handle on opposing sides;

a main aperture at the top of the vessel;

a filter comprising a perforated container, the filter being insertable into the vessel through the main aperture;

a lid-receiving recess disposed about an upper opening in the filter, the lid-receiving recess having an annular form and defining an axis;

a strainer comprising a perforated receptacle;

a lid having a form complementary to the lid-receiving recess and configured for closing the upper opening in the filter;

an axially-extending telescopic coupling by which the lid and tea strainer are connected to rotate together; and

one of a cam and follower on the filter, the other of the cam and follower on the filter strainer such that rotation of the lid relative to the filter engages the follower with the cam to raise or lower the strainer.

With loose tea or tea bags in the strainer the user is able, by simply turning the lid, to drop the tea into the water, or draw the tea up out of the water and thereby control the steeping process. To assist with this the vessel, the filter and the strainer are preferably transparent. The lid can be turned between positions in which the strainer lowered and raised respectively and if released in these positions, or any intermediate position, the strainer is maintained at the chosen height.

Preferably the cam includes a helical surface that extends about the axis. Preferably the follower comprises an abutment having a face for engaging the cam.

Preferably the cam includes upper and lower surfaces aligned substantially in transverse planes and joined by the helical surface, the helical surface including a middle portion having a constant helix angle, with transition portions either side of the middle portion, the transition portions having varying helix angles for smoothly joining the middle portion to the upper and lower surfaces respectively.

Preferably the perforated container comprising the filter has substantially cylindrical, coaxial inner and outer faces, a projection is disposed on the inner face and the cam is formed along an edge of the projection.

Preferably the perforate receptacle comprising the strainer has substantially cylindrical, coaxial inner and outer faces, the follower comprises first and second abutments projecting from diametrically opposing sides of the outer face of the receptacle and the cam comprises first and second cams for engaging the first and second abutments respectively.

Preferably the abutments comprise an axial end of a rib projecting from an outer face of the strainer.

Preferably the lid includes a diametrical flange by which the lid may be held by a user. Preferably the flange is bounded either side by a concavity.

Preferably the filter includes a tab formed to project into the lid-receiving recess, the lid includes a groove elongated circumferentially, the groove having a mouth opening in the axial direction, such that the lid and filter are secured by a push-and-turn action in which the lid is pushed to enter the tab into the mouth, before the lid is turned to receive the tab in the groove.

Preferably when the mouths and tabs are axially aligned, then the followers are angularly aligned with the lower surfaces of the cam.

Preferably the tab comprises a pair of diametrically opposed tabs and the mouth comprises a pair of diametrically opposed mouths.

Preferably the telescopic coupling comprises an axial stem formed on the lid, with an opening extending through the stem, the strainer includes a shaft telescopically received in the opening in the stem, the opening on the stem having a non-circular cross section and the shaft, or a fixture on the shaft, having a form complementary to the non-circular cross section.

Preferably the tea brewing apparatus further comprises a power base for supporting the vessel, and a first electrical connector on the power base, the vessel further comprises an electrical heating element and a second electrical connector on the vessel, such that with the vessel supported upon the power base the first and second connectors are engaged to supply power to the element.

Preferably the filter further includes a flange extending circumferentially about the upper opening, the main aperture is bounded by a lip for supporting the filter, and cooperating locking means on the lip and flange for preventing rotation of the filter relative to the vessel. The cooperating means may include a notch and projection pair of complementary form.

Preferably lower walls of the filter and strainer are perforated by tapered openings which narrow toward an inner side of the lower walls. Preferably strainer comprises circumferentially spaced, axially aligned slots extending between the inner and outer faces of the strainer. Preferably filter comprises openings extending between the inner and outer faces of the filter, which openings narrow toward an inner face.

In another aspect the invention provides a tea steeping assembly comprising:

a filter comprising a perforated container, the filter being configured for insertion into a tea brewing vessel;

a lid-receiving recess disposed about an upper opening in the filter, the recess having an annular form and defining an axis;

a strainer comprising a perforated receptacle;

a lid having a form complementary to the lid-receiving recess and configured for closing the upper opening in the filter;

an axially-extending telescopic coupling by which the lid and tea strainer are connected to rotate together; and

one of a cam and follower on the filter, the other of the cam and follower on the strainer such that rotation of the lid relative to the filter engages the follower with the cam to raise or lower the strainer.

### BRIEF DESCRIPTION OF THE DRAWINGS

Preferred forms of the present invention will now be described by way of example with reference to the accompanying drawings, wherein:

FIG. 1 is an exploded perspective view from above of tea brewing apparatus according to a first embodiment of the invention;

FIG. 2 is a fragmentary transverse section through the lower part of the filter of the apparatus of FIG. 1;

FIG. 3 is a schematic development of the cam of the apparatus of FIG. 1;

FIG. 4 is a half-sectioned elevation of the tea steeping assembly the apparatus of FIG. 1, and

FIG. 5 is a section along line AA of FIG. 4.

### DESCRIPTION OF THE PREFERRED EMBODIMENTS

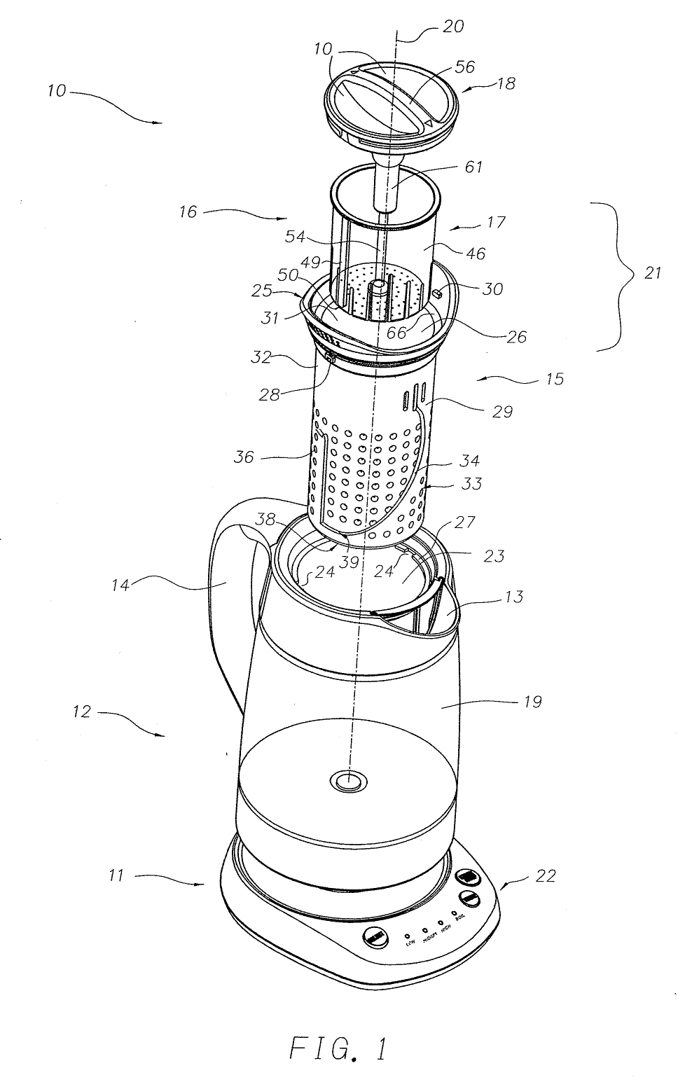

Referring to FIG. 1, tea brewing apparatus 10 generally includes a tea steeping assembly 21 removably connectable to a kettle 12. The kettle 12 includes a power base 11 and a vessel 19 having a spout 13 and a handle 14 on opposing sides. The tea steeping assembly 21 includes a filter 15 and a rotating assembly 16 which includes in turn, a tea strainer 17 and a lid 18. The vessel 19 may be made of glass, and the filter 15 and strainer 17 of transparent plastics. The filter 15 and rotating assembly 16 are connected generally coaxially with the central axis 20. As used herein, the term “axial” refers to a direction substantially parallel to the central axis 20. The term “radial” refers to a direction substantially orthogonal to the axis 20. The term “circumferential” refers to the direction of a circular arc having a radius substantially orthogonal to the axis 20.

The kettle 12 may be of a known type in which the power base 11 supports the vessel 19. The vessel 19 further comprises an electrical heating element (not shown) and a first electrical connector on the power base, and a second electrical connector on the vessel, cooperate such that with the vessel 19 supported upon the power base the connectors are engaged to supply power to the heating element. Temperature controls 22 may be provided on the power base 11. The kettle is advantageous, in providing for control of the temperature of the brewing water, however it is not essential, and the invention is of course applicable to a tea pot without heating elements.

A generally circular main aperture 23 is provided at the top of the vessel 19, bounded by a circumferential lip 27. Notches 24 are disposed in opposing sides of the lip 27. A flange 25 extends circumferentially about an upper opening 26 in the filter 15. The filter 15 includes a perforated container 29 integral with the flange 25. The axial length of the filter 15 is smaller than that of the vessel 19, and when the perforated container 29 is inserted through the main aperture 23, the flange 25 rests upon the lip 27 to support the filter 15. Radially outwardly extending projections 28 on the flange are of complementary form to the notches 24 in which they are received, for preventing rotation of the filter 15 relative to the vessel 19.

An annular lid-receiving recess 66 is disposed about the upper opening 26, the axis 20 extending centrally through the lid-receiving recess 19. On diametrically opposing sides of the flange 25, tabs 30 project from a lateral wall into the lid-receiving recess 66.

The perforated container 29 comprising the filter has substantially cylindrical, coaxial inner and outer faces 31 and 32. Part of the lower wall of the perforated container 29 is thickened, providing a projection inwardly of the surface 31 to form cams 33. The cams 33 are disposed on opposing sides of the container 29, each including a helical surface 34 formed along an edge of the projection and which that extends about the axis 20.

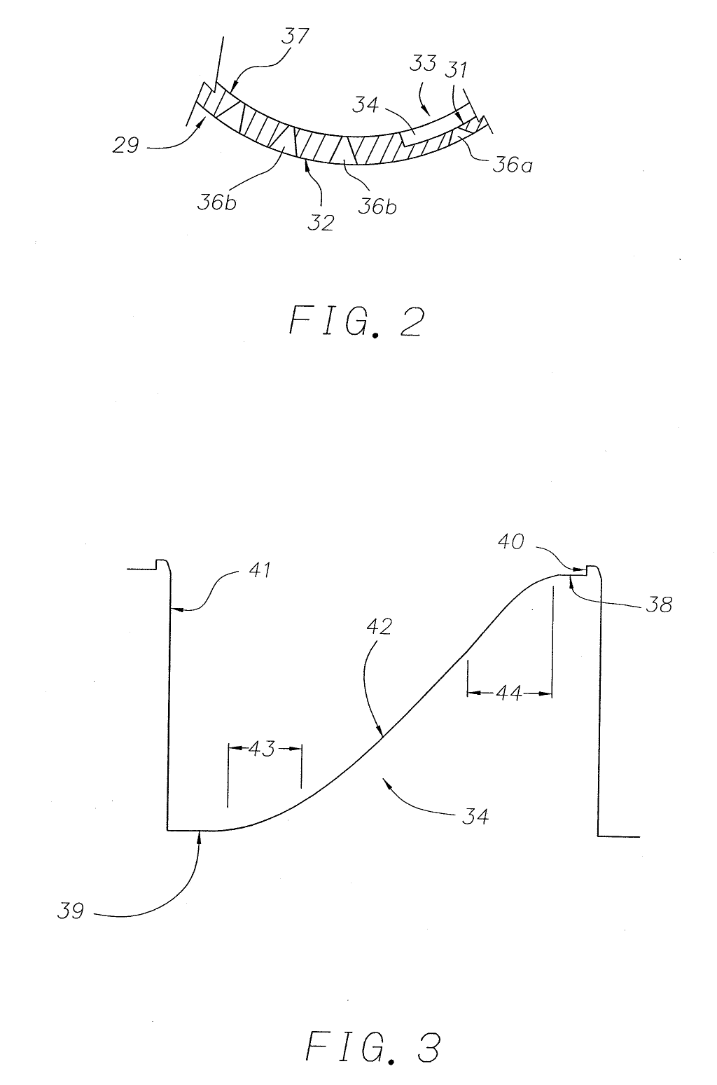

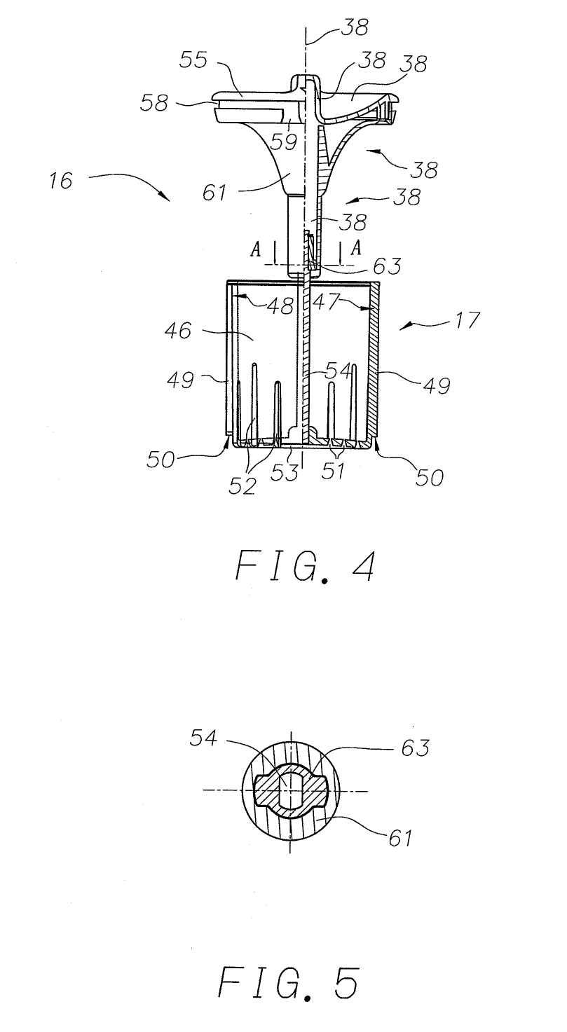

Referring to FIG. 2, the perforated container 29 is perforated by tapered openings 36a, 36b arrayed in the side walls. The openings 36a extend between the inner and outer faces 31 and 32 of the filter, while the openings 36b extend between the inner side 37 of the cam 33 and the outer face 32. The openings 36a, 36b taper to narrow toward the inner face 31, 37 Likewise the circular lower walls 38 at the base of the perforated container 29 are perforated by tapered openings (not shown) which narrow toward the inside.

As seen in FIG. 3, the cam 33 includes upper and lower surfaces 38, 39 aligned substantially in respective planes transverse to the axis 20. Adjacent the surfaces 38, 39 the axially-aligned edges 40, 41 limit the angular extent of each cam. The upper and lower surfaces 38, 39 are joined by the helical surface 34, the helical surface 34 including a middle portion 42 having a constant helix angle, with transition portions 43, 44 either side of the middle portion 42, the transition portions 43, 44 having varying helix angles for smoothly joining the middle portion 42 to the upper and lower surfaces respectively.

The strainer 17 comprises a perforated receptacle 46 with substantially cylindrical, coaxial inner and outer faces 47, 48. Projecting from the outer face 48 on diametrically opposite sides of the receptacle 46 are axially elongated ribs 49. A follower in the form of an abutment 50 on the lower axial ends of each rib 49 engages with one of the cams 33 for raising and lowering the strainer 17. The lower wall 53 of the strainer are perforated by tapered openings 51 which narrow toward an inner side of the lower walls. Circumferentially spaced, axially aligned slots 52 extend between the inner and outer faces 47, 48.

The lid 18 has an upper disc-shaped portion 55 having a form complementary to the lid-receiving recess 66 and configured for closing the upper opening 26 in the filter 15. The disc-shaped portion 55 includes a diametrical flange 56 by which the lid 18 may be grasped and turned by a user. The flange 55 is bounded either side by a concavity 57. Grooves 58 in the disc-shaped portion 55 are elongated circumferentially, and each has a mouth 59 opening in the axial direction, the mouths being aligned in diametrically opposing sides of the lid. The lid 18 and filter 17 are secured by a push-and-turn action in which the lid 18 is pushed to enter the tabs 30 into the mouths 59, before the lid is turned to receive the tabs 30 in the grooves 58.

An axially-extending telescopic coupling 60 comprises an axial stem 61 fixed to the disc-shaped portion 55, provided with an axially extending opening 62. A shaft 54 is telescopically received in the opening 62 in the stem 61. One end of the shaft 54 is fixed to the lower wall 53 and the other end is fixed to a block 63. The block 63 has a non-circular cross section complementary to the non-circular cross section of the opening 62, preventing relative rotation between the lid 18 and strainer 17 while permitting free telescoping movement.

In use, the filter 15 sealingly engages about the main aperture 23 and the water is boiled. Loose tea leaves or tea bags are placed in the strainer 17, and holding the lid 18, the strainer 17 is dropped through the opening 26. If the mouths 59 and tabs are axially aligned, then the strainer 17 drops into the water and down until the follower abutments 50 abut the lower surfaces 39. Otherwise, if the mouths 59 and tabs are not axially aligned then the abutments 50 first abut the cam surface 34 as the strainer is lowered, and in this angular orientation the user must turn the lid 18 in order to close the opening 26. Turning the lid to place the tabs 30 and mouths 59 in alignment, closes the opening 26 and lowers the strainer as the abutments 50 slide down the cam surface 34. Once the tea has brewed as desired, the lid 18 is rotated relative to the filter 15, engaging the abutment 50 with the cam to raise the strainer 17 without opening the lid 18. This allows the kettle to keep the tea hot without the resulting brew becoming too strong. When raised the abutment rests upon the upper surface 38. If the lid 18 is released in any angular position between these end positions, the strainer 17 is maintained at the chosen height.

Aspects of the present invention have been described by way of example only and it should be appreciated that modifications and additions may be made thereto without departing from the scope thereof.

1. A tea brewing apparatus comprising:
a vessel having a top and, on opposite sides, a pouring device and a handle;
a main aperture at the top of the vessel;
a filter comprising a perforated container, the filter being insertable into the vessel through the main aperture;
an annular lid-receiving recess disposed about an upper opening in the filter, and having a central axis defining an axial direction;
a strainer comprising a perforated receptacle;
a lid complementary in shape to the lid-receiving recess for closing the upper opening in the filter;
an axially-extending telescopic coupling by which the lid and the strainer are connected to rotate together; and
one of a cam and a follower on the filter, the other of the cam and the follower being on the filter strainer such that rotation of the lid relative to the filter engages the follower with the cam to raise and lower the strainer.

2. The apparatus of claim 1 wherein the cam includes a helical surface that extends about the axis.

3. The apparatus of claim 1 wherein the follower comprises an abutment having a face for engaging the cam.

4. The apparatus of claim 2 wherein the cam includes upper and lower surfaces aligned substantially in transverse planes and joined by the helical surface, the helical surface including a middle portion having a constant helix angle, and transition portions on both sides of the middle portion, the transition portions having varying helix angles for smoothly joining the middle portion to the upper and lower surfaces, respectively.

5. The apparatus of claim 1 wherein the perforated container has substantially cylindrical, coaxial inner and outer faces, and a projection disposed on the inner face, and
the cam is located along an edge of the projection.

6. The apparatus of claim 1 wherein
the perforated receptacle has substantially cylindrical, coaxial inner and outer faces,
the follower comprises first and second abutments projecting from diametrically opposing sides of the outer face of the receptacle, and
the cam comprises first and second cams for engaging the first and second abutments, respectively.

7. The apparatus of claim 3 wherein the abutment comprises an axial end of a rib projecting from an outer face of the strainer.

8. The apparatus of claim 1 wherein
the lid includes a diametrical flange by which the lid may be held by a user, and
the flange is bounded by a concavity.

9. The apparatus of claim 1 wherein
the filter includes a tab projecting into the lid-receiving recess,
the lid includes a groove that is elongated circumferentially, and
the groove has a mouth opening in the axial direction, such that the lid and filter are secured by a push-and-turn action in which the lid is pushed to enter the tab into the mouth, before the lid is turned to receive the tab in the groove.

10. The apparatus of claim 9 wherein, when the mouth and the tab are axially aligned, the follower is angularly aligned with lower surfaces of the cam.

11. The apparatus of claim 10 wherein the tab comprises a pair of diametrically opposed tabs and the mouth comprises a pair of diametrically opposed mouths.

12. The apparatus of claim 1 wherein
the telescopic coupling comprises an axial stem located on the lid, with an opening extending through the stem,
the strainer includes a shaft telescopically received in the opening in the stem,
the opening on the stem has a non-circular cross section, and
the shaft, or a fixture on the shaft, has a shape complementary to the non-circular cross section.

13. The apparatus of claim 1 further comprising a power base for supporting the vessel, and a first electrical connector on the power base, wherein the vessel further comprises an electrical heating element and a second electrical connector on the vessel, such that with the vessel supported upon the power base, the first and second connectors are engaged to supply power to the electrical element.

14. The apparatus of claim 1 wherein the filter further includes a flange extending circumferentially about the upper opening, the main aperture is bounded by a lip for supporting the filter, and further including cooperating locking means on the lip and the flange for preventing rotation of the filter relative to the vessel.

15. The apparatus of claim 1 wherein lower walls of the filter and strainer include perforating tapered openings which narrow toward an inner side of the lower walls.

16. The apparatus of claim 1 wherein the strainer comprises circumferentially spaced, axially aligned slots extending between inner and outer faces of the strainer.

17. The apparatus of claim 1 wherein the filter comprises openings extending between inner and outer faces of the filter, wherein the openings narrow toward the inner face.

18. A tea brewing apparatus comprising:
a vessel having a top and, on opposing sides, a pouring device and a handle;
a main aperture at the top of the vessel;
a filter comprising a substantially cylindrical perforated container, the filter being insertable into the vessel through the main aperture;
an annular lid-receiving recess disposed about an upper opening in the filter and having a central axis defining an axial direction;
a strainer comprising a substantially cylindrical perforated receptacle;
a lid complementary in shape to the lid-receiving recess for closing the upper opening in the filter;
an axially-extending telescopic coupling by which the lid and the strainer are connected to rotate together, the telescopic coupling comprising an axial stem located on the lid, with an opening extending through the stem, the strainer including a shaft telescopically received in the opening in the stem, the opening in the stem having a non-circular cross section and the shaft, or a fixture on the shaft, having a shape complementary to the non-circular cross section; and
one of a cam and a follower on the filter, the other of the cam and the follower being on the filter strainer such that rotation of the lid relative to the filter engages the follower with the cam to raise and lower the strainer, wherein the cam includes a helical surface that extends about the axis and the follower comprises an abutment having a face for engaging the cam.

19. The apparatus of claim 18 wherein
the perforated container has coaxial inner and outer faces, a projection is disposed on the inner face, and the cam is located along an edge of the projection, and
the perforated receptacle has coaxial inner and outer faces, the follower comprises first and second abutments projecting from diametrically opposing sides of the outer face of the receptacle, and the cam comprises first and second cams for engaging the first and second abutments, respectively.

20. The apparatus of claim 18 wherein the filter further includes a flange extending circumferentially about the upper opening, the main aperture is bounded by a lip for supporting the filter, and further including cooperating locking means on the lip and the flange for preventing rotation of the filter relative to the vessel.

21. The apparatus of claim 19 wherein filter comprises openings extending between the inner and outer faces of the filter, which openings narrow toward an inner face.

22. The apparatus of claim 20 wherein
the filter includes a tab projecting into the lid-receiving recess,
the lid includes a groove that is elongated circumferentially, and
the groove has a mouth opening in the axial direction, such that the lid and filter are secured by a push-and-turn action in which the lid is pushed to enter the tab into the mouth, before the lid is turned to receive the tab in the groove.

23. The apparatus of claim 22 wherein when the mouth and the tab are axially aligned, the follower is angularly aligned with lower surfaces of the cam.

24. The apparatus of claim 23 wherein the tab comprises a pair of diametrically opposed tabs and the mouth comprises a pair of diametrically opposed mouths.

25. The apparatus of claim 18 wherein the cam includes upper and lower surfaces aligned substantially in transverse planes and joined by the helical surface, the helical surface including a middle portion having a constant helix angle, and transition portions on both sides of the middle portion, the transition portions having varying helix angles for smoothly joining the middle portion to the upper and lower surfaces_{.}, respectively.

26. The apparatus of claim 18 further comprising a power base for supporting the vessel, and a first electrical connector on the power base, wherein the vessel further comprises an electrical heating element and a second electrical connector on the vessel, such that, with the vessel supported upon the power bas; the first and second connectors are engaged to supply power to the electrical element.

27. A tea steeping assembly comprising:
a filter comprising a perforated container for insertion into a tea brewing vessel;
an annular lid-receiving recess disposed about an upper opening in the filter and having a central axis defining an axial direction;
a strainer comprising a perforated receptacle;
a lid complementary in shape to the lid-receiving recess for closing the upper opening in the filter;
an axially-extending telescopic coupling by which the lid and the strainer are connected to rotate together; and
one of a cam and a follower on the filter, the other of the cam and the follower being on the strainer such that rotation of the lid relative to the filter engages the follower with the cam to raise and lower the strainer.
